(19) United States
(12) Patent Application Publication
(10) Pub. No.: US 2009/0019985 A1
(43) Pub. Date: Jan. 22, 2009

(54) DRUM AND METHOD OF MANUFACTURE

(76) Inventor: Ronald J. Casanta, Naples, FL (US)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(21) Appl. No.: 11/778,403

(22) Filed: Jul. 16, 2007

(51) Int. Cl. G10D 13/02

(52) U.S. Cl. 84/411 R

(57) ABSTRACT

A drum includes a shell and a resonant head made of wood or adhesively bonded wood plies. A hole may be provided in the resonant head, and the resonant head may be adhesively bonded to the shell.

### FIELD OF THE INVENTION

The field relates to musical instruments, especially drums.

### BACKGROUND

Drums are the earliest musical instrument known to man. They have also been used for communication devices over long distances. The advent of the drum set at the turn of the century allowed a single drummer to provide percussion for a band. Drum technology used natural materials such hides and intestines for better and resonant heads on a drum. With the advent of synthetic materials in the 40's and 50's, drum technology was revolutionized. Specifically, many drums are formed of a shell, a batter head, and a resonant head opposite of the batter head.

Modern drum shells are made of a plurality of layers of wood glued together in plies. Combined with synthetic heads, these drums provide consistent and tunable acoustic resonates when the batter head is struck with a drum stick or other striking instrument.

One of the problems with modern drums is that the transmission of air inside from the drum shell to the resonant head is never perfect. Thus, when a shell drum is used in a recording studio, sound engineers have a very difficult time controlling overring and the ‘booming’ effect that synthetic resonant heads emit.

### SUMMARY OF THE INVENTION

A drum comprises a shell and a bottom portion adhesively bonded to the shell. The bottom portion being made of wood or a laminate of wood layers adhesively bonded together.

One advantage of the drum is that the construction may reduce over tinging that causes difficulties for recording the resonance of conventional drums in studio settings. Another advantage is that the drum provides a preferred mellowness and modified tonal qualities.

### BRIEF DESCRIPTION OF THE FIGURES

FIG. 1 illustrates a cross section of a shell, ring and resonant head adhesively bonded using a mitered portion.

FIG. 2 illustrates a bottom plan view of an example of a base drum.

FIG. 3 illustrates beveling of a one edge of a shell.

FIG. 4 illustrates an example of a drum.

FIG. 5 illustrates a bottom plan view of a shell and a reinforcing ring.

FIG. 6 shows a cross-sectional view of a reinforcing ring.

FIG. 7 depicts an example of an attachment of a resonant face to a drum shell.

FIG. 8 shows a semi-circular portion of an exterior surface of a shell.

FIGS. 9A-9D illustrate various detailed views of joints of a shell and a resonant head or head blank.

### DETAILED DESCRIPTION

The examples described and the drawings rendered are illustrative and are not to be read as limiting the scope of the invention as it is defined by the appended claims.

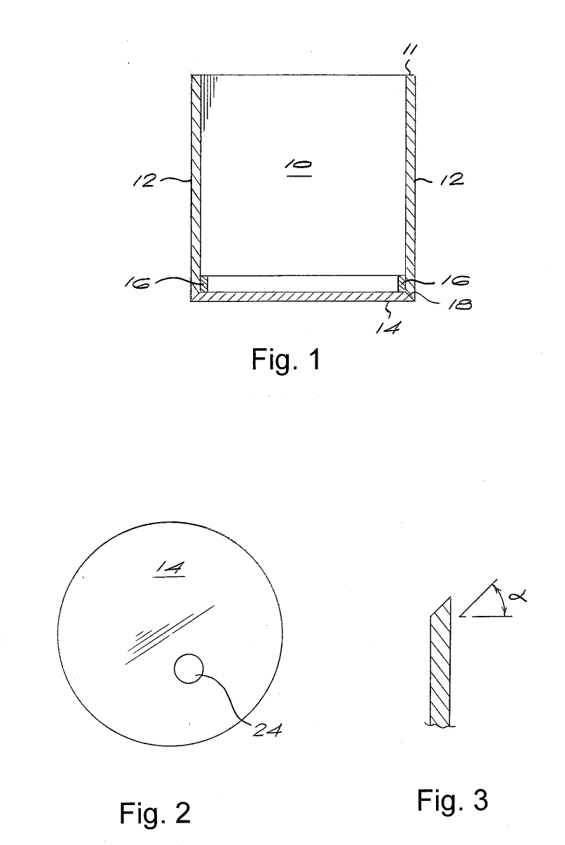

An example of a drum 10 is illustrated in FIG. 1. The shell 12 may be of any construction, such as wood or a laminate of wood plies adhesively bonded one to the other. The choice of wood effects the quality and tone of the sound produced by the shell, when used as a drum.

A resonant head 14 is made of wood or a laminate of wood plies and may be adhesively bonded to the shell 12. A ring 16, which may be an opened or closed ring, may be used to provide a larger bonding surface for the resonant head 14 of the drum. The resonant head 14 may be considered the bottom of the drum 10, even if the drum rests on its side, such as a base drum. A reinforcing ring 16 may adhesively attached to a bottom portion of the shell. In one example, the reinforcing ring 16 is of the same material as the shell 12 and has the same thickness as the shell 12. As shown in FIG. 5, the shell 12 has an exterior surface 22 and an interior surface 26. A ring 16 may have an axial length B of one inch from top to bottom of the ring 16. The thickness A of the ring 16 may equal to the shell thickness.

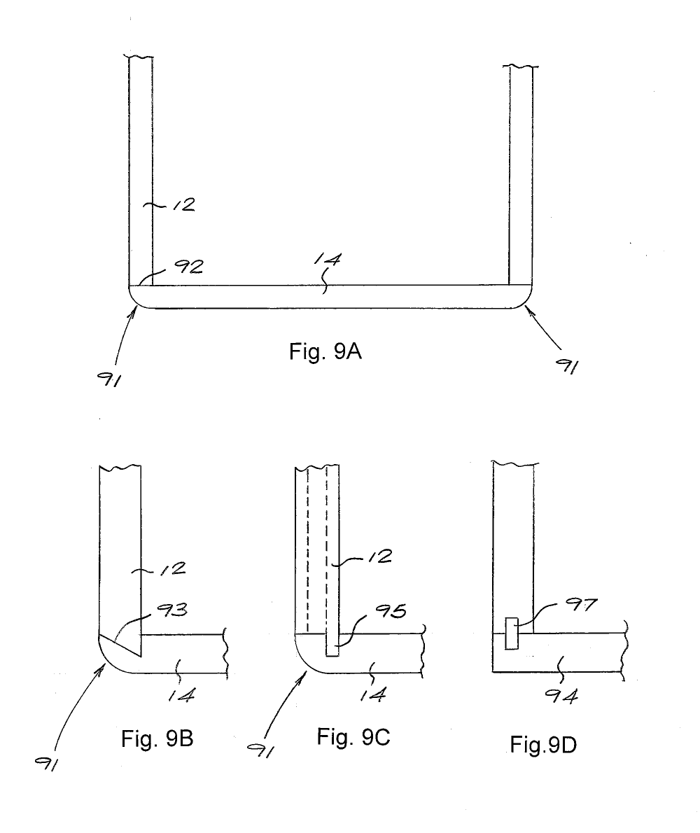

A mitered portion 18 may be prepared by cutting, shaping, grinding or sanding to shape and size a mitered portion of the edge of the bottom 14 to a mitered portion of the bottom edge of the shell 12. Any or all edges 18, 11 may be cut at an angle α, as shown in FIG. 3, in order to better transfer resonant sound between the shell and heads and/or to increase the adhesive bonding area. Alternatively, the edge of the shell 12 contacting the resonant head 14 may abut the flat upper surface of the resonant head 14. For example, the bottom resonant portion of the drum shell may be formed at a substantially squared-off edge for maximizing contact to a flat face of the resonant head, such as by cutting, shaping, grinding and/or sanding. In one example the shell is bonded to a blank that extends beyond the exterior surface of the shell. This eases centering and clamping during adhesive bonding. Then, the blank is curt, ground, and/or sanded to form a resonant head with a rounded-over exterior edge 91. For example, a portion of a blank 94 is illustrated in FIG. 9D. FIGS. 9A-9D illustrate various joints formed between the shell 12 and the resonant head 14, such as squared off abutment 92, a reverse miter 93, a rabbit 95 and a spline 97. The examples are illustrations and not to scale.

In FIG. 3, the inside diameter of an end of a shell is bevelled to an angle α, which is known to adjust the sound of a drum, including the resonance of the shell when the batter head is percussively struck.

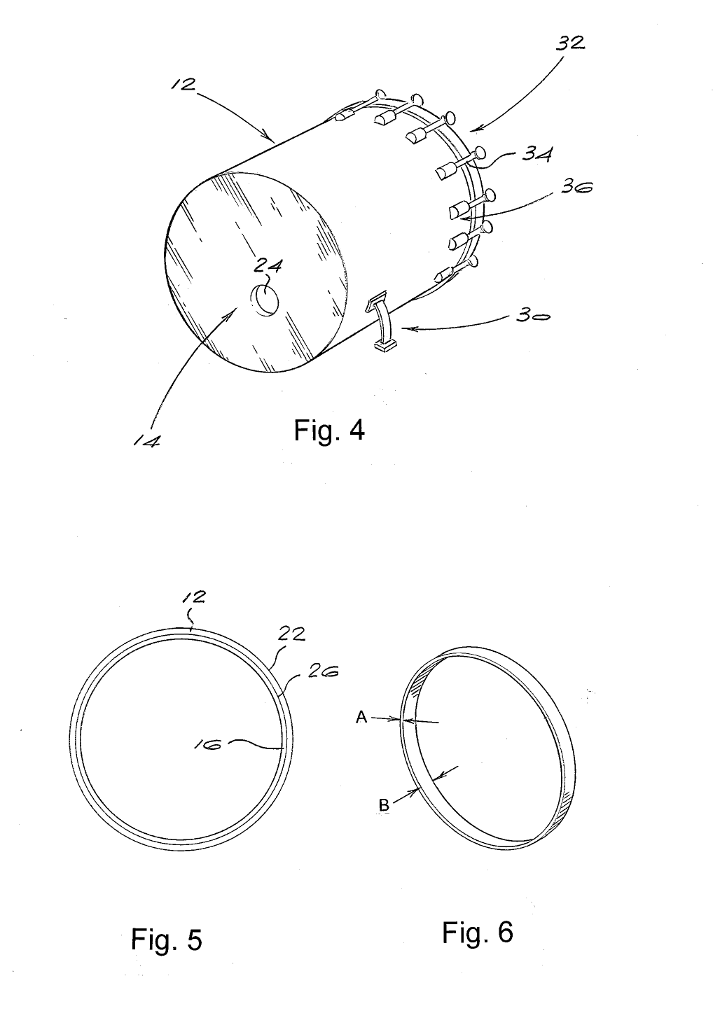

In FIG. 4, a drum shell 12 has an internal reinforcing ring 16 with a thin wood veneer resonant head 14. In this example, a bass drum is shown that includes a conventional tensioning hoop batter side 32 using a conventional tension rod 34, a conventional tension lug 36, and a bass drum stabilizing spur 30. A vent hole 24 is provided. The opposite end of the shell 12 is bonded to a resonant head 14 without the use of conventional lugs 36.

The hole 24 provides air flow into and out of the shell during percussive striking of the batter head, which is referred to as “venting”. The hole 24 may have an area less than the area enclosed by the resonant head 14. For example, the area of the hole 24 may be in the range from 1% to 3% of the bottom surface area.

In one example, a bass drum has a shell 12 having a 22″ diameter (55.9 cm) and a 14″ depth (35.6 cm) with a substantially 90° angle between the edge of the shell bonded to the flat surface of the resonant head 14 and the exterior surface of the shell. The thickness of the resonant head 14 may be selected to be that of a 3/16 inch (about 0.45-0.48 cm) sheet of plywood, The plywood may be adhesively bonded to the shell 12 after a reinforcing ring 16 is adhesively bonded to the shell 12. The ring 16 may be used to increase the bonding area. After tuning of the batter head using the lugs 36 and the tensioners 34, the drum is ready to be played. In one example, a plurality of holes are disposed in the resonant head 14 as a brand; which have a less resonant sound when percussively resonated. The cumulate area of holes may be about 1-3% of the total surface area of the resonant had, for example.

Generally, thin resonant heads are preferred for increased resonance compared to thicker heads, which have a less resonant sound when percussively resonated. Various modifications are shown to improve adhesive bonding between the shall 12 and the resonant head 14. A proper adhesive bond is important to transfer of resonant energy between shell and resonant head.

A range in thickness of a resonant head from about 1/16″ (0.15-0.16 cm) to ⅜″ (about 0.90-0.96 cm) may be used, depending on the tonal qualities and total area of the resonant bottom 14. More preferably, a range of ⅛″ (about 0.29 to 0.32 cm) to about 0.60-0.64 cm is preferred for a tom or a bass drum. A batter head may be made of a synthetic or natural material and may be conventionally fixed on the opposite end of the shell from the resonant head 14. Mahogany, such as African Mahogany, Maple, Birch, Beech, Oak and other woods may be used alone or in combination and as a solid, a lay-up or a laminate adhesively bonded to form the bottom 14 and/or shell 12 of a drum 10. Unlike traditional resonant heads, a wooden or wood ply head 14 may be joined by abutting a squared-off end of the shell 12 to a flat surface of the head.

In FIG. 5, a view of a drum shell is shown with a reinforcing ring 16 adhesively attached. In this example, the reinforcing ring 16 has an axial length B of about 1 inch (2.54 cm) from top to bottom. The exterior surface of the ring is adhesively bonded to the interior surface of the shell and increase the bonding area between the resonant head and combination of shell and ring.

In FIG. 6, a cross-sectional view of a reinforcing ring is depicted. The ring may have an one inch width (42) and the thickness 44 of the ring may be equal to the thickness of the drum shell or may be selected to have another thickness.

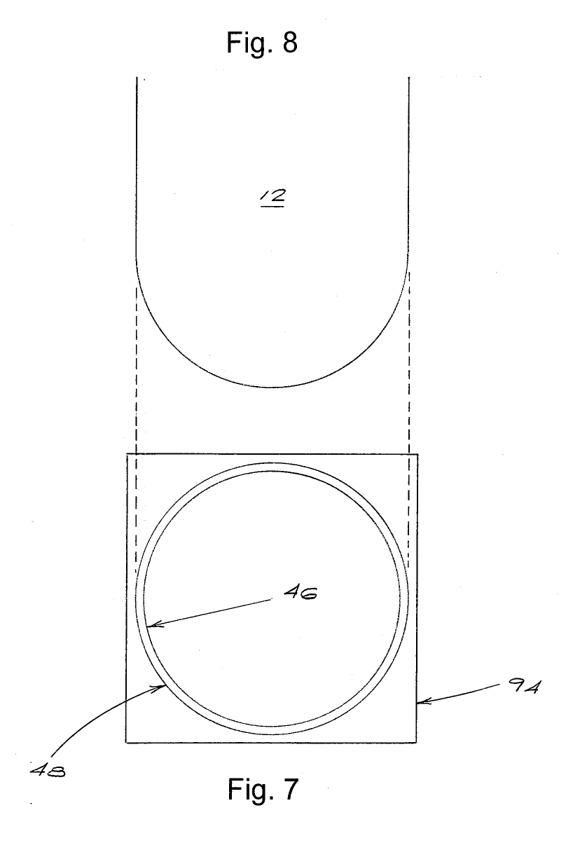

Any high quality adhesive may be used, such as a quality marine grade wood glue or Elmer's®.¹ glue in combination with an applied pressure. In FIG. 7, inside circumference (46) and outside circumference (48) of a shell and/or the reinforcing ring are marked onto a veneer blank 94, A thin layer of adhesive, such as a contact cement or glue, is applied to the marked area of veneer and to the squared-off edge of the drum shell and/or ring. The components are aligned and pressed in contact. In one example, the shell is clamped, applying a fixed pressure between the components being adhered together. In another example, a pressure is applied, such as a dead weight. For example, 24 hours are allowed for curing of the head and/or shell. Then, the balance of the veneer is removed from the resonant head and a finishing. ¹Elmer's® is a registered trademark of Elmer's Products, Inc.

Alternative combinations and variations of the examples provided will become apparent based on this disclosure. It is not possible to provide specific examples for all of the many possible combinations and variations of the embodiments described, but such combinations and variations may be claims that eventually issue.

What is claimed:

1. A drum comprising:
a shell; and
a resonant head adhesively bonded to the shell, wherein the resonant head is made of wood or a plurality of adhesively bonded wood plies.

2. The drum of claim 1, wherein the resonant head is made of a plurality of adhesively bonded wood plies.

3. The drum of claim 2, wherein at least one of the plurality of adhesively bonded wood plies is of maple.

4. The drum of claim 1, wherein at least a portion of the outer edge of the resonant head is mitered at an angle, such that the length of at least a portion of the resonant head equals the length and angle of a mitered edge of the shell to which the resonant head is adhesively bonded.

5. The drum of claim 1, further comprising a ring portion having an outer surface adhesively bonded to a lower edge of the shell and a portion of the resonant head.

6. The drum of claim 5, further comprising a batter head fixed on an end of the shell opposite of the resonant head.

7. The drum of claim 6, wherein the batter head is a synthetic material.

8. The drum of claim 6, wherein the resonant head has a hole formed in a portion of the resonant head having an area less than an area enclosed by the resonant head such that air is capable of transferring between the space within the shell and exterior to during percussive striking of the batter the shell through the hold head.
